(19) United States
(12) Patent Application Publication
(10) Pub. No.: US 2021/0192466 A1
(43) Pub. Date: Jun. 24, 2021

(54) EVENT REQUEST PRIORITIZATION

(71) Applicant: Lenovo (Singapore) Pte. Ltd., Singapore (SG)

(72) Inventors: Philip L. Childs, Fort Wayne, IN (US); Russell Speight VanBlon, Raleigh, NC (US); Jonathan Co Lee, Cary, NC (US)

(21) Appl. No.: 16/724,765

(22) Filed: Dec. 23, 2019

(51) Int. Cl. G06Q 10/10; G06F 16/2457

(52) U.S. Cl. CPC G06Q 10/1095; G06F 16/24575

(57) ABSTRACT

One embodiment provides a method, including: receiving, at an information handling device, an event request for a user; determining, using a processor and based on context data, a priority associated with the event request; and performing, based on the determined priority associated with the event request, an action. Other aspects are described and claimed.

### BACKGROUND

Individuals receive a variety of communications each day on their information handling devices (“devices”), for example laptop and/or personal computers, smart phones, tablet devices, hybrid devices, and the like. These communications may include requests that invite the individual to attend an in-person or virtual meeting or event. Responsive to accepting the invitation, the occasion may be reflected on a calendar associated with the individual.

### BRIEF SUMMARY

In summary, one aspect provides a method, comprising: receiving, at an information handling device, an event request for a user; determining, using a processor and based on context data, a priority associated with the event request; and performing, based on the determined priority associated with the event request, an action.

Another aspect provides an information handling device, comprising: a processor; a memory device that stores instructions executable by the processor to: receive an event request for a user; determine, based on context data, a priority associated with the event request; and perform, based on the determined priority associated with the event request, an action.

A further aspect provides a product, comprising: a storage device that stores code, the code being executable by a processor and comprising: code that receives an event request for a user; code that determines, based on context data, a priority associated with the event request; and code that performs, based on the determined priority associated with the event request, an action.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of addressing event requests using context data.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

When an event invitation is accepted by an individual, details associated with the accepted event may be reflected on an individual's virtual calendar. More particularly, a time slot during which the event is scheduled to occur may be visually distinguished to the individual and/or additional details associated with the event may be readily available (e.g., event location, event attendees, etc.). These conventional scheduling techniques make it convenient for a user to receive, accept, and display various events.

Conventional systems may allow individuals to accept any and all event invitations, regardless of whether a conflict, or time overlap, exists between two or more events. It stems to reason that an increased number of event invitations increase the likelihood that such conflicts may occur. In these situations, it may become difficult and time consuming for an individual to determine which events are more important than others. When conflicts are not resolved in a timely manner, issues may arise for the individual, the event organizer, or others.

Existing solutions are lacking with respect to calendaring conflict resolution. For example, current systems may provide a notification to a user that a conflict exists but may nevertheless allow the user to maintain the conflict (e.g., by allowing the user to accept a conflicting event request or by allowing a user to add a conflicting item to their “To do” list, etc.). As another example, existing systems may flag event emails as being important, but these flags generally reflect an importance designation imparted on the event by the sender, a sentiment that may not be mutually shared by the recipient. In these scenarios, the recipient may prioritize other events over the “important” event, thereby leading to a conflict.

Accordingly, an embodiment provides a method for dynamically and automatically managing incoming event requests by using context data associated with the event request. In an embodiment, a user may receive an event request (e.g., a meeting request, an activity request, etc.). An embodiment may then determine a priority associated with the event request by accessing available context data. The context data may correspond to a relationship between an event requestor and the recipient, a keyword in the event request, a position of the user in the event request communication recipient list, recipient behavior data with regards to previous similar event requests, and the like. Based on the determined priority associated with the event request, an embodiment may thereafter perform an action (e.g., prioritizing the event request with respect to another scheduled meeting, automatically responding to the event request based on the priority, dynamically resolving any conflicts arising from the event request, etc.). Such a method may therefore better manage event requests and reduce or eliminate the instances of unresolved event conflicts.

The illustrated example embodiments will be best understood by reference to the figures. The following description is intended only by way of example, and simply illustrates certain example embodiments.

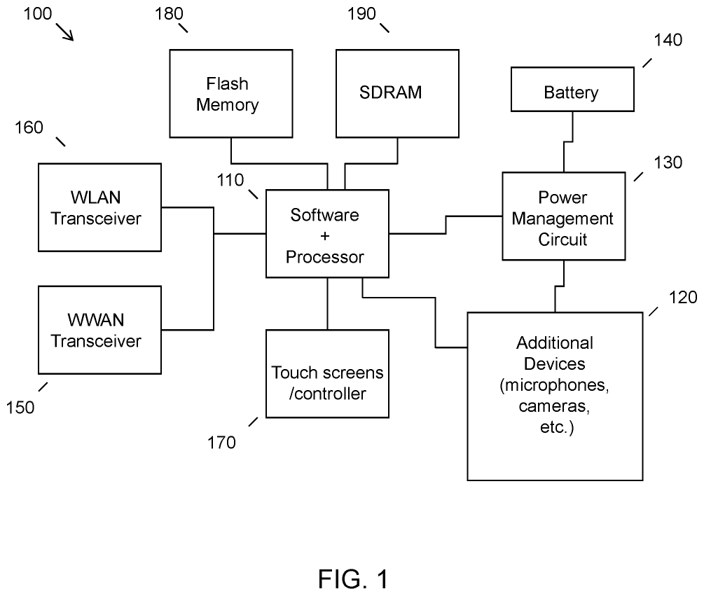

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

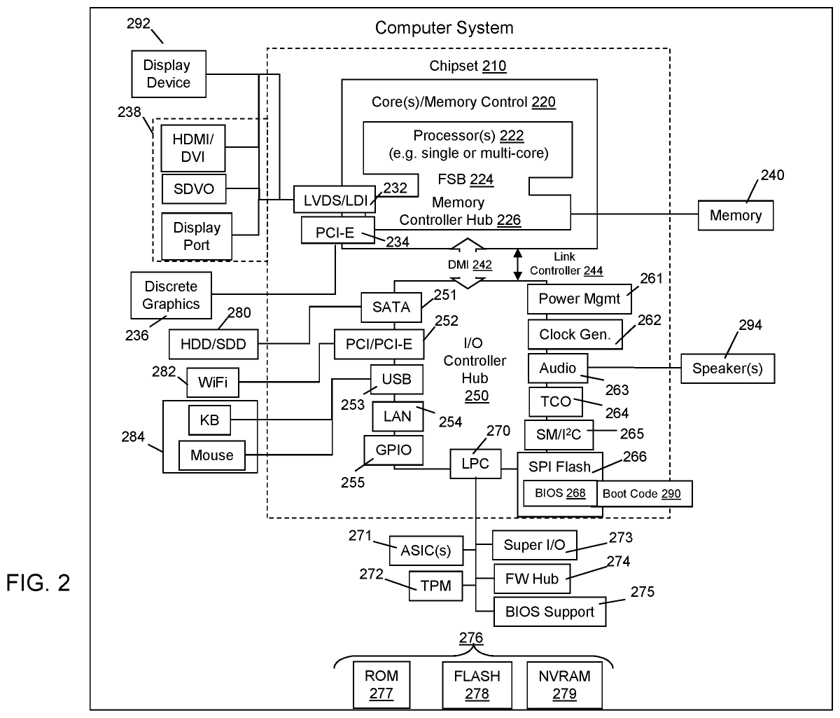

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices capable of supporting one or more calendaring applications and capable of receiving and processing event requests directed to those calendaring applications. For example, the circuitry outlined in FIG. 1 may be implemented in a smart phone or tablet embodiment, whereas the circuitry outlined in FIG. 2 may be implemented in a laptop.

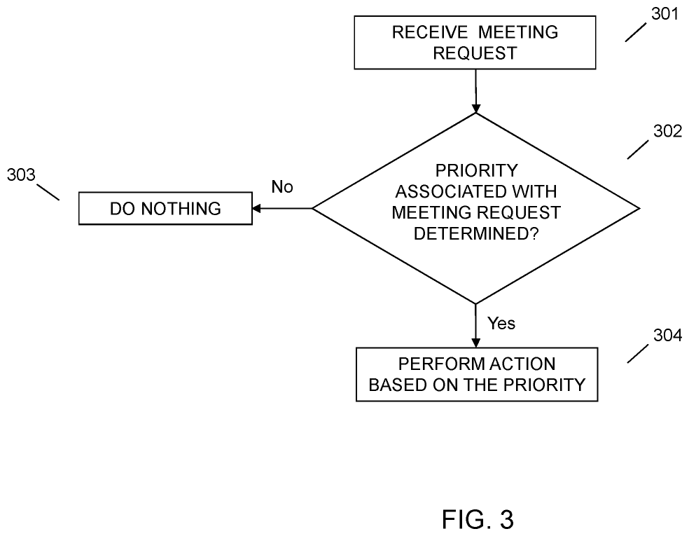

Referring now to FIG. 3, an embodiment provides a method for dynamically managing incoming event requests by utilizing context data. At 301, an embodiment may receive an event request directed to a user. In an embodiment, the event request may be created by an event requestor and may contain one or more of: a description of an event, a date of an event, a location of an event, an event recipient list, and the like. The event request may be transmitted to the user by the event requestor and may be received at a device that supports at least one email and/or calendaring application. In an embodiment, the event request may take the form of an email, a text message a social media communication, and the like. For simplicity purposes, the remainder of this application will be described with reference to an event request that takes the form of an email communication received at an email application that supports calendaring capabilities. However, it is important to note that this designation is not limiting and that the event request may be received or detected by other means, as previously described.

At 302, an embodiment may determine a priority associated with the event request by accessing available context data. An embodiment may review a permissions list to determine the types of context data a user has allowed the email application access to. In an embodiment, the following determination techniques may be performed automatically, without receipt of any additional user input.

In an embodiment, the context data may correspond to a relationship between the event requestor and the user and the priority may be determined based upon the relationship. Stated differently, an event request received from an event requestor determined to have a close relationship with the user may be prioritized over events whose creators have a more distant relationship with the user. For example, an event request received from a user's boss, an important client, their spouse, etc. may be prioritized over an event request received from the user's friend. In an embodiment, a user may assign a relationship to each event requestor and also assign a priority designation to each type of relationship. Additionally or alternatively, the relationship may be dynamically deduced by an embodiment (e.g., via analysis of prior communications between the user and the event requestor, via other context data, etc.) and a priority designation may be automatically assigned to each relationship (e.g., by reference to a predetermined list of relationship based priority designations, etc.).

In an embodiment, the context data may correspond to a keyword present in the event request and the priority may be based on the presence or absence of the keyword. Non-limiting examples of keywords include relevant project names, acronyms, importance-indicating trigger words (e.g., “important”, “high priority”, “urgent”, etc.), and the like. In an embodiment, the keyword may be present in virtually any portion of the email (e.g., in the title of the email, the body of the email, etc.). Identification of the keyword may be facilitated by analyzing the event request (e.g., using one or more conventional textual analysis techniques, etc.) and thereafter comparing one or more identified words in the event request to a predetermined list of known keywords (e.g., stored locally or remotely in an accessible storage database, etc.). If a match is identified, then the matched word may be considered a keyword. In an embodiment, the known keywords may be established by the manufacturer of the email application or, additionally or alternatively, may be designated by a user.

Event requests comprising one or more keywords may be automatically prioritized over other event requests containing no keywords. In situations where two or more event requests both comprise keywords, an embodiment may be able to prioritize one event request over another based upon reference to a keyword priority designation database. In this database, different keywords may be assigned different priority levels, where a higher priority assignment indicates a more important keyword. Accordingly, the event request having the higher priority keyword may be assigned a higher priority than the event request having the lower priority keyword. Additionally or alternatively, an embodiment may also weigh the number of identified keywords in an event request in the priority decision. For example, an event request having three identified keywords may be prioritized over another event request having only a single identified keyword.

In an embodiment, the context data may correspond to the past behavior of the user with respect to how they have managed and/or reacted to particular types of event requests and the priority may be based on this past behavior. The type of event request may relate to the nature of the event (e.g., a work-based event, a leisure-based event, etc.), the identity of the event requestor (e.g., a work-based requestor, a family-based requestor, a friend requestor, etc.), the activity level of the event (e.g., a meeting vs. a physical activity, etc.), and the like. In an embodiment, common behaviors of users responsive to receiving the event request may include immediately accepting the event request, immediately declining the event request, accepting or declining the event request after a prolonged period of time, not responding to the event request, requesting to reschedule the event request, and the like. An embodiment may assign a priority to a new event request based upon the identified past behavior of the user with respect to similar types of event requests. For example, a meeting request received from the user's boss may be assigned a high priority designation because an embodiment may identify that a user has quickly accepted past meeting requests from their boss. As another example, an after work team-building activity request may be assigned a low priority designation because an embodiment may identify that a user has declined or not responded to prior team-building activity requests.

In an embodiment, the context data may correspond to a perceived importance of a user in the event request and the priority may be based on this perceived importance. The perceived importance may be impacted by one or more attributes associated with the event request. For example, an event request that lists the user in the “TO” subject line may be prioritized over another event request that lists the user in the “CC” subject line. As another example, an event request in which the user's attendance is listed as “required” may be prioritized over another event request in which the user's attendance is listed as “optional”. In yet another example, an event request flagged as important may be prioritized over another event request that has not been flagged at all.

Responsive to not determining, at 302, a priority associated with the event request, an embodiment may, at 303, take no additional action or, alternatively, treat the event request using traditional means. Conversely, responsive to determining, at 302, a priority associated with the event request, an embodiment may, at 304, perform an action based on the determined priority.

In an embodiment, the action may correspond to a prioritization of one event over another. As briefly discussed above, certain events may be prioritized over other events based upon their priority designation. The practical effect of this is that when a conflict arises between two or more events an embodiment may resolve the conflict by automatically accepting or maintaining the higher priority event at the original time and/or automatically cancelling or rescheduling the lower priority event(s). Additionally or alternatively, an embodiment may dynamically suggest an alternative time for one or more of the events in order to negate the conflict. In an embodiment, the action may correspond to a transmission of a notification to an event requestor. For example, an embodiment may transmit an indication to an event requestor that the user will attend the event, the user will not attend event, or that the user would like the event rescheduled to another time.

The various embodiments described herein thus represent a technical improvement to conventional methods of managing incoming event requests. Using the techniques described herein, an embodiment may receive an event request and determine a priority associated with the event request. The priority determination may be facilitated by analyzing one or more times of available context data as described above. Responsive to determining a priority of the event in the request, an embodiment may perform one or more actions (e.g., accept the event, decline the event, suggest another time for the event, etc.). Such a method may thereby manage event requests in a timely manner in order to eliminate or reduce the negative effects resulting from event conflicts.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device, an event request for a user;
determining, using a processor and based on context data, a priority associated with the event request; and
performing, based on the determined priority associated with the event request, an action.

2. The method of claim 1, wherein the context data corresponds to a relationship between an event requestor and the user and wherein the priority is determined based on the relationship.

3. The method of claim 1, wherein the context data corresponds to at least one keyword in the event request and wherein the priority is determined based on the at least one keyword.

4. The method of claim 1, wherein the context data corresponds to past behavior data of the user with respect to a type of the event request and wherein the priority is determined based on the past behavior data.

5. The method of claim 1, wherein the context data corresponds to a position of the user in an event request recipient list and wherein the priority is determined based on the position.

6. The method of claim 1, wherein the performing the action comprises prioritizing the event request with respect to at least one other scheduled meeting.

7. The method of claim 1, further comprising identifying a conflict between the event request and at least one other scheduled event.

8. The method of claim 7, wherein the performing the action comprises resolving the conflict based upon the priority determined priority.

9. The method of claim 8, wherein the resolving the conflict comprises suggesting an alternative time for at least one of: an event associated with the event request and the at least one other scheduled meeting.

10. The method of claim 1, wherein the performing the action comprises automatically responding to the event request based on the determined priority.

11. An information handling device, comprising:
a processor;
a memory device that stores instructions executable by the processor to:
receive an event request for a user;
determine, based on context data, a priority associated with the event request; and
perform, based on the determined priority associated with the event request, an action.

12. The information handling device of claim 11, wherein the context data corresponds to a relationship between an event requestor and the user and wherein the priority is determined based on the relationship.

13. The information handling device of claim 11, wherein the context data corresponds to at least one keyword in the event request and wherein the priority is determined based on the at least one keyword.

14. The information handling device of claim 11, wherein the context data corresponds to past behavior data of the user with respect to a type of the event request and wherein the priority is determined based on the past behavior data.

15. The information handling device of claim 11, wherein the context data corresponds to a position of the user in an event request recipient list and wherein the priority is determined based on the position.

16. The information handling device of claim 11, wherein the instructions executable by the processor to perform the action comprise instructions executable by the processor to prioritize the event request with respect to at least one other scheduled event.

17. The information handling device of claim 11, wherein the instructions are further executable by the processor to identify a conflict between the event request and at least one other scheduled event.

18. The information handling device of claim 17, wherein the instructions executable by the processor to perform the action comprise instructions executable by the processor to resolve the conflict based upon the determined priority, wherein the instructions executable by the processor to resolve the conflict comprise instructions executable by the processor to suggest an alternative time for at least one of: an event associated with the event request and the at least one other scheduled meeting.

19. The information handling device of claim 11, wherein the instructions executable by the processor to perform the action comprise instructions executable by the processor to automatically respond to the event request based on the determined priority.

20. A product, comprising:
a storage device that stores code, the code being executable by a processor and comprising:
code that receives an event request for a user;
code that determines, based on context data, a priority associated with the event request; and
code that performs, based on the determined priority associated with the event request, an action.
